(19) United States
(12) Patent Application Publication
(10) Pub. No.: US 2013/0144779 A1
(43) Pub. Date: Jun. 6, 2013

(54) SOFTWARE AND METHOD FOR ALLOWING PAYMENT OF MERCHANDISE AND SERVICES ELECTRONICALLY, THROUGH A SMART DEVICE, WITH A PREDETERMINED ACCOUNT

(71) Applicant: Rodrigo Azuriz-Cannella, Canton, GA (US)

(72) Inventor: Rodrigo Azuriz-Cannella, Canton, GA (US)

(21) Appl. No.: 13/707,571

(22) Filed: Dec. 6, 2012

Related U.S. Application Data
(60) Provisional application No. 61/567,544, filed on Dec. 6, 2011.

(51) Int. Cl. G06Q 20/12

(52) U.S. Cl. CPC G06Q 20/12; G06Q 20/3223
USPC 705/39

(57) ABSTRACT

A method and software application allows smart device users, such as smartphone users, to pay for their merchandise and services with a predetermined credit or debit account. The method does not require the user to take out, expose, or give out their credit or debit card. The method of the present invention can increase transaction financial safety and efficiency, while protecting the environment from the printing and disposal of physical plastic credit and debit cards.

### CROSS-REFERENCE TO RELATED APPLICATION

This application claims the benefit of priority of U.S. provisional application number 61/567,544, filed Dec. 6, 2011, the contents of which are herein incorporated by reference.

### BACKGROUND OF THE INVENTION

The present invention relates to methods for affecting payments and, more particularly, to software and methods for allowing payment of merchandise and services electronically, through a smart device, such as a smartphone, with a predetermined account.

When taken out to make a payment, credit and debit cards are exposed to identity theft. Bystanders have been known to photograph cards as users give and receive them back from a merchant. Other methods of identity theft are associated with the giving and receiving of physical credit can debit cards. In addition, physical debit and credit cards are subject to wear and tear. Over time, a physical debit or credit card can crack, wear down or the magnetic stripe on the back of the card can become worn or inactive, requiring the user to obtain a new card from the issuer.

As can be seen, there is a need for an improved process for making payments that does not expose a user's credit or debit card to public exposure and possible identity theft.

### SUMMARY OF THE INVENTION

In one aspect of the present invention, computer software written in computer code disposed on a computer readable, non-transient media, the computer code having code configured to provide the method steps for making payment to a merchant, the method steps comprising signing into a computer application on a smart device; selecting a payment option on a screen of the smart device; scanning a code provided by the merchant, the code having transaction details; electronically transferring funds from a predetermined account to the merchant; and providing a user with a transaction confirmation.

In another aspect of the present invention, a method for electronically making payment from a user to a merchant with a smart device comprises signing into a computer application loaded onto the smart device; selecting a payment option on a screen of the smart device; scanning a code provided by the merchant, the code having transaction details; electronically transferring funds from a predetermined account to the merchant; and providing the user with a transaction confirmation.

These and other features, aspects and advantages of the present invention will become better understood with reference to the following drawings, description and claims.

### BRIEF DESCRIPTION OF THE DRAWINGS

FIG. 1 is a screen shot showing an exemplary sign-in screen in the method and software of the present invention;

FIG. 2 is a screen shot showing an exemplary main screen following the sign-in screen of FIG. 1;

FIG. 3 is a screen shot showing an exemplary payment screen, allowing the user to add extras to their payment;

FIG. 4 is a screen shot showing an exemplary transaction approval screen, allowing the user to organize the payment, print a receipt, discard the approval or file it for later;

FIG. 5 is a screen shot showing exemplary menu options available when selected from the screen shown in FIG. 2; and

FIG. 6 is a screen shot showing an exemplary tax deductible transaction report that can be printed or emailed.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method and software application that allows smart device users, such as smartphone users, to pay for their merchandise and services with a predetermined credit or debit account. The method does not require the user to take out, expose, or give out their credit or debit card. The method of the present invention can increase transaction financial safety and efficiency, while protecting the environment from the printing and disposal of physical plastic credit and debit cards.

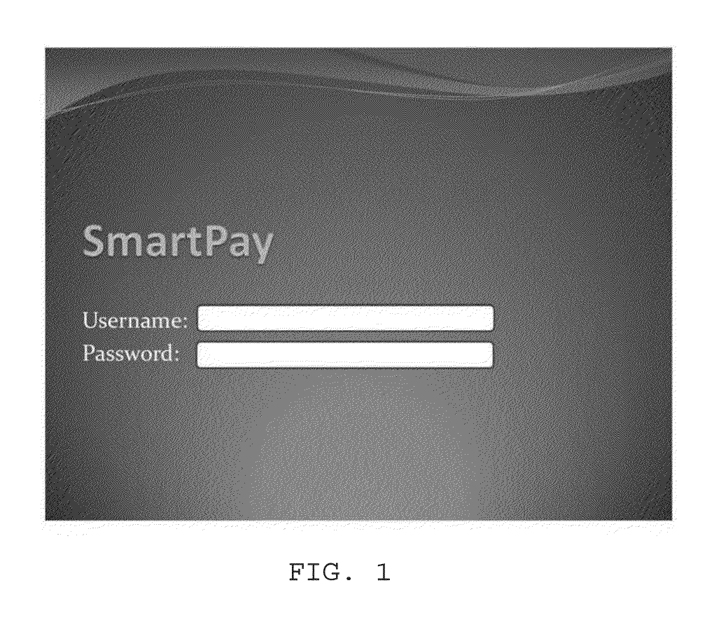

Referring to FIG. 1, a user can obtain an application on their smart device. For example, a user can download an application onto their smartphone that includes program code to perform the method steps as herein described. The software application can be written in an appropriate programming code and can be saved in a non-transient media on the smartphone. Once installed and running, the user is initially provided with a sign-in screen, requiring the user to enter a username and password.

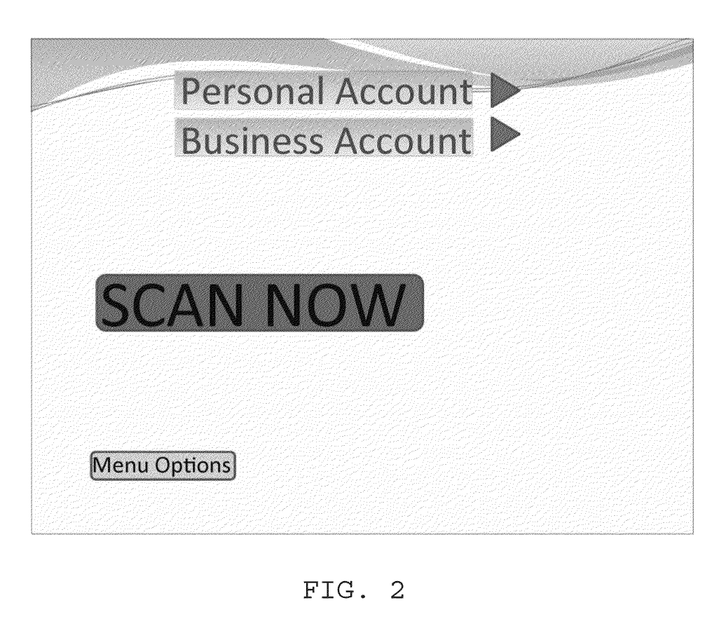

Once the system is accessed, a first screen, as shown in FIG. 2, can be provided. This screen allows a user to access a personal account, to access a business account, to get to menu options, or to scan a code provided by a merchant to make a payment. Typically, a vendor providing goods or services can provide a scannable code that contains all the necessary transaction details. When the user scans in this code, they can make payment to the vendor without needing to show a credit or debit card.

The vendor can be a “brick and mortar” vendor, where the code to be scanned is provided on a vendor receipt, a vendor screen or the like. In some embodiments, the vendor can be an online vendor, where the code is provided on a computer screen when the purchaser is making the payment. The purchaser can then simply scan the code with their phone to make payment.

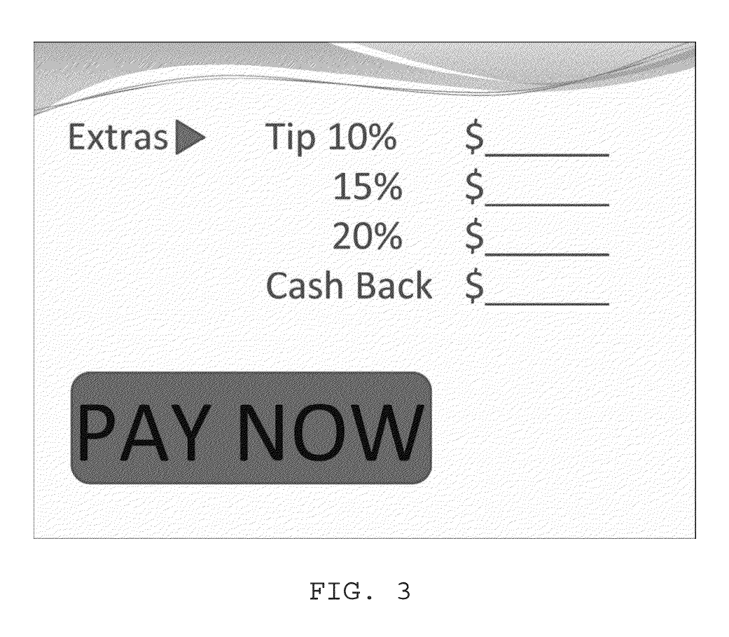

After the bar code is scanned (by pressing “scan now” as shown in FIG. 2 and scanning the code), depending on the transaction, a “extras” page, as shown in FIG. 3, can appear. The extras page will allow the user to add a tip, request cash back, or the like. This page will include a button to pay now. When that button is pressed, payment is made from the predetermined account of the user to the merchant.

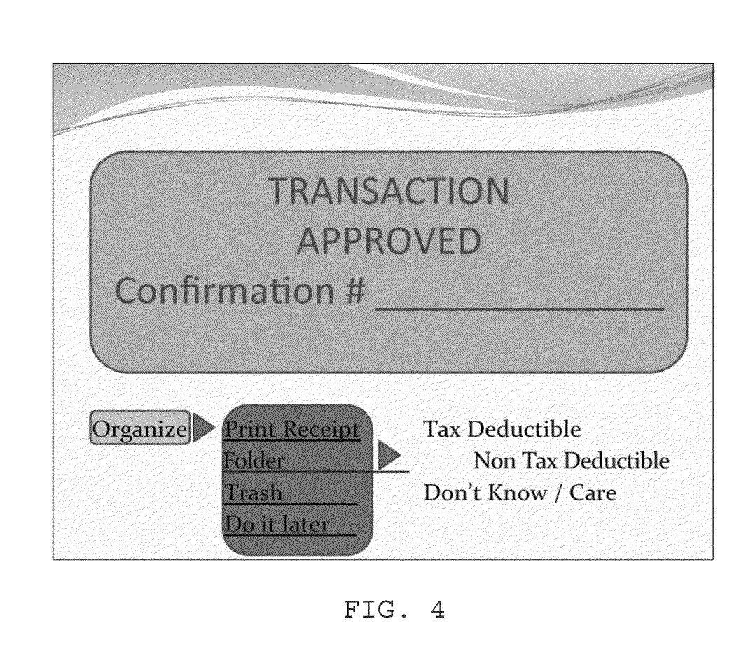

As shown in FIG. 4, if the transaction is approved, a confirmation page will appear. The user can then file the receipt, print the receipt, discard the receipt, or file it for later organization.

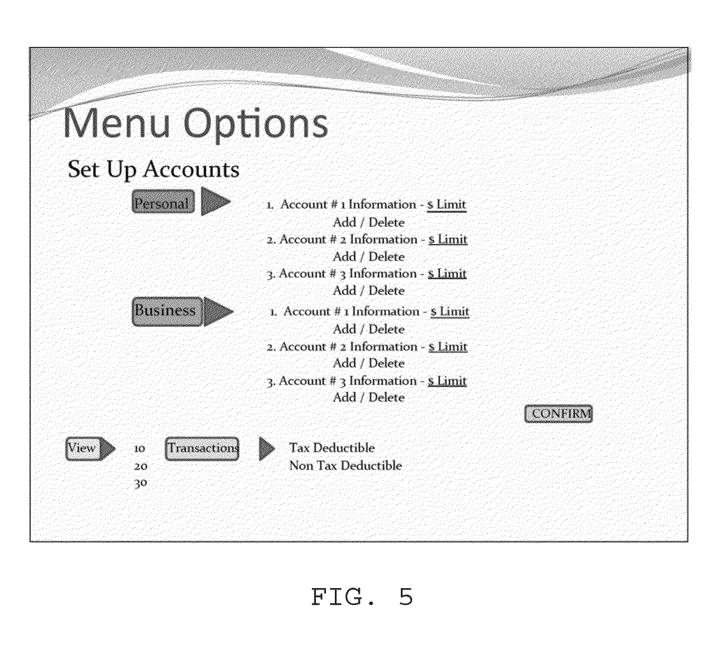

Referring back to FIG. 2 and to FIG. 5, various menu options can be provided to the user. The menu options can allow a user to set up various personal and business accounts, set limits for the accounts, make one account a default account, view transactions, and the like.

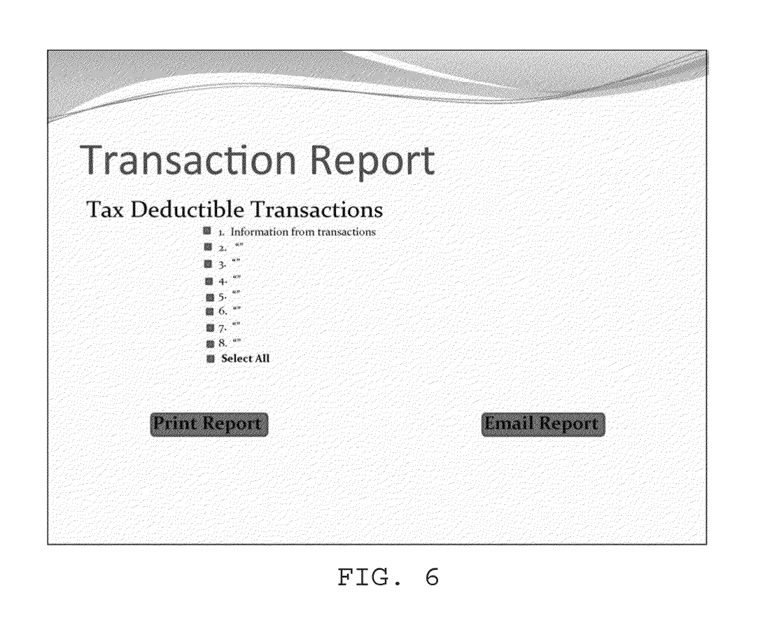

Various reports can be generated by the application and methods of the present invention. For example, items filed as tax deductible transactions may be summarized in a report as shown in FIG. 6. This report can be printed from the application or may be emailed to the user or to an alternate email address, as desired.

While the present invention is described as a smartphone application, the application may be available for other computing devices, such as laptops, desktops, tablet computers, and the like. While these computing devices may not be used to scan and make payments, a user can use these computing devices to access their accounts, run reports, set up accounts, or the like.

It should be understood, of course, that the foregoing relates to exemplary embodiments of the invention and that modifications may be made without departing from the spirit and scope of the invention as set forth in the following claims.

What is claimed is:

1. Computer software written in computer code disposed on a computer readable, non-transient media, the computer code having code configured to provide the method steps for making payment to a merchant, the method steps comprising:
signing into a computer application on a smart device;
selecting a payment option on a screen of the smart device;
scanning a code provided by the merchant, the code having transaction details;
electronically transferring funds from a predetermined account to the merchant; and
providing a user with a transaction confirmation.

2. The computer software of claim 1, further comprising computer code to provide the step of configuring the predetermined account as one of a plurality of possible accounts.

3. The computer software of claim 1, further comprising computer code to provide the step of generating a report describing one or more types of transactions.

4. The computer software of claim 1, further comprising computer code to provide the step of adding a tip or requesting cash back in a transaction prior to electronically transferring funds from the predetermined account to the merchant.

5. The computer software of claim 1, further comprising computer code to provide the step of allowing a user to organize an approved transaction.

6. The computer software of claim 1, wherein the smart device is a smartphone.

7. A method for electronically making payment from a user to a merchant with a smart device, the method comprising:
signing into a computer application loaded onto the smart device;
selecting a payment option on a screen of the smart device;
scanning a code provided by the merchant, the code having transaction details;
electronically transferring funds from a predetermined account to the merchant; and
providing the user with a transaction confirmation.

8. The method of claim 7, further comprising configuring the predetermined account as one of a plurality of possible accounts.

9. The method of claim 7, further comprising generating a report describing one or more types of transactions.

10. The method of claim 7, further comprising adding a tip or requesting cash back in a transaction prior to electronically transferring funds from the predetermined account to the merchant.

11. The method of claim 7, further comprising allowing a user to organize an approved transaction on the smart device.

12. The method of claim 7, wherein the smart device is a smartphone.
